(19) United States
(12) Patent Application Publication
(10) Pub. No.: US 2010/0213676 A1
(43) Pub. Date: Aug. 26, 2010

(54) TOOL SYSTEM

(76) Inventor: Ulrich Bohne, Kohlberg (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/682,424

(22) PCT Filed: Sep. 2, 2008
(86) PCT No.: PCT/EP2008/061519

§ 371 Date: Apr. 9, 2010

(30) Foreign Application Priority Data
Oct. 10, 2007 (DE) 102007048821.3

(51) Int. Cl. B23B 31/12; B25D 17/08; B25D 17/02

(52) U.S. Cl. 279/14; 408/226; 279/66

(57) ABSTRACT

The invention relates to a tool system which includes an exchangeable rotary tool for electric hand-held machine tools, preferably with a drill and/or hammer function, in particular for an electric hammer drill, and an electric drill, in particular a percussion drill. The tool system also includes at least two tool holders that are embodied as tool fittings that are associated with the hand-held machine tools and are different types. The rotary tool has an insertable shaft to be accommodated in the respective tool holder of the hand-held machine tools, the shaft having at least two slaving ribs that are diametrically opposed and that extend along the shaft for rotational engagement. The tool fitting of a first type is embodied as a positive fit fitting and another tool fitting of the second type as a multi-jaw clamping chuck. The slaving ribs have a width and a height such that, in the clamped state, they are at a lateral distance from the clamping jaws of the multi jaw clamping chuck.

The invention relates to a tool system having an interchangeable rotary tool for handheld electric power tools, preferably with a drilling and/or hammering function, as generically defined by the preamble to claim 1.

### PRIOR ART

Tool systems with interchangeable rotary tools for handheld electric power tools are known. For instance, tool systems for clamping in conventional three jaw chucks are in existence, in which the rotary tools have an essentially cylindrical shaft of more or less circular cross section. In these rotary tools, the rotation of the tool is primary. Tool systems also exist in which it is less the rotary motion and more a percussive motion that is primary, as is the case for instance with the SDS-Plus receptacle. In it, in particular, very easy changing of the rotary tool (such as a rock drill) is wanted, which is why the insert shafts of SDS-Plus drills have a special geometry. Tool systems of hexagonal cross section also exist, of the kind in screwdriver bits, for instance. It is common to all these tool systems that they have the disadvantage of not being sufficiently compatible as desired with other tool systems; that is, an insert tool or rotary tool can be connected to only a corresponding receptacle in the associated tool system, or there are limitations in connection to a tool receptacle of a different tool system. For instance, it is not possible to clamp SDS-Plus receptacles in three-jaw chucks, since there is no possibility for central guidance of the three clamping jaws in any position for the special geometric shaping of the SDS-Plus shafts or other shafts that are suitable for fast-change systems and are found on the market.

### DISCLOSURE OF THE INVENTION

It is the object of the invention to furnish a tool system having an interchangeable rotary tool for handheld electric power tools that overcomes the aforementioned disadvantages and enables the greatest possible interoperability between individual tool systems, especially for use in various tool receptacles of handheld electric power tools.

To that end, a tool system having an interchangeable rotary tool for handheld electric power tools is proposed, preferably with a drilling and/or hammering function, in particular for an electric rotary hammer, and an electric power drill, in particular a percussion power drill, and having at least two tool holders as a tool receptacle, which are associated with the handheld power tools and are of different types, wherein the rotary tool has an insert shaft for reception in the respective tool holder of the handheld power tools, which has two slaving ribs, extending along the length of the insert shaft and diametrically opposite one another, for rotary slaving; wherein the tool receptacle is embodied as a form-locking receptacle as a first type and a further tool receptacle is embodied as a three jaw chuck as a second type; and wherein the slaving ribs are embodied as so wide and high that—in the clamped state—they have a lateral spacing from the clamping jaws of the three jaw chuck. For the interoperability of the tool system, it is definitive that the slaving ribs that are embodied on the insert shaft of the rotary tool not collide in the clamped state with the clamping jaws of the three jaw chuck. So that the insert shaft can be centrally clamped in the three jaw chuck with its three clamping jaws, spaced apart from one another by 120°, the insert shaft is of circular cross section. The slaving ribs embodied on it that are required for rotary slaving of the rotary tool in the other, first type of tool receptacle, namely the form-locking receptacle, must be embodied such that they do not in turn occupy the three-dimensional volume occupied by the clamping jaws of the three jaw chuck during clamping, especially in the clamped state. As a result, there is a limit to their width (essentially, their length in the circumferential direction) and to their height (that is, essentially their length in the radial direction). At the same time, the slaving ribs must be high and wide enough to assure adequate torque transmission, as a rotary slaving means, in the first type of tool receptacle, namely the form-locking receptacle. For especially good torque transmission, the slaving ribs are disposed diametrically opposite one another on the circumference of the insert shaft of the rotary tool.

In a further version of the tool system, the insert shaft has precisely two slaving ribs. Although an embodiment with more than two slaving ribs is possible, it is not necessary. With the diametrically opposed two slaving ribs described, torque transmission in the required way and to the required extent can be assured, and the possibility that further slaving ribs can collide with the clamping jaws of the three jaw chuck is avoided.

In a preferred embodiment, the slaving rib has an essentially square or rectangular rib cross section. This means that the boundary faces of the slaving ribs that do not rest on the insert shaft or on the circumference of the insert shaft have right angles to one another and are embodied rectilinearly. It is understood that the cross section of the slaving ribs where they join the circumference of the insert shaft is adapted in shape to the circumference, that is, the circular cross section of the insert shaft, and is not straight, while the other boundary lines of the cross section of the slaving rib are straight and have right angles to one another.

In another embodiment, the rib cross section is embodied as essentially trapezoidal. The rib cross section here is essentially a trapezoid, and the shorter side of the trapezoid can be located in or on the cross section of the insert shaft or facing away from it.

In a preferred embodiment, it is provided that the rib cross section is embodied as essentially mirror-symmetrical to an axis of symmetry that is formed as an extension of a radius of the insert shaft. If the radius of the circular cross section of the insert shaft is lengthened with the slaving rib, the result is the axis of symmetry to which the cross section of the slaving rib is mirror-symmetrical. To the left and right of the axis of symmetry, as a mirror axis, viewed in cross section, the rib cross section minor-symmetrically has the same content per unit of surface areas. With this kind of symmetrical embodiment, the force engagement for torque transmission is equally good in both directions of rotation of the rotary tool. Moreover, the symmetrical embodiment is economical and easy to manufacture.

In a further embodiment, the slaving ribs have long sides, which form flat slaving flanks. The long sides of the slaving ribs serve to transmit torque through the tool receptacle of the first type, namely the form-locking receptacle. Typically, such tool receptacles furnish axial securing means as well as guide grooves that serve the purpose of receiving the slaving ribs. These grooves are engaged by the long sides of the flat slaving flanks and transmit the torque, transmitted from the tool receptacle, to the rotary tool. The embodiment as flat slaving flanks is especially well suited for torque transmission, since a relatively large-area flat face for engagement of the tool receptacle is embodied; at the same time, it is easy and favorable to manufacture.

In a preferred embodiment of the tool system, the long sides of each slaving rib extend parallel to one another. When the long sides of each slaving rib have a parallel course, the torque transmission is effected independently of the direction of rotation; it can thus be assured that the torque transmission is obtained in an equally good way in every direction of rotation. Depending on the manufacturing technique for the insert shaft, it is possible for the long sides or slaving ribs to radially adjoin top sides that are not flat; in that case, between the long sides and the respective top side, a right angle may not be enclosed in all places, or there may not be even any right angle; the cross-sectional contour of the slaving ribs in that case is not rectangular or is only essentially rectangular. What is essential to the invention in this respect is only that the slaving flanks are guided adequately in the corresponding tool receptacle and offer adequate engagement for torque transmission by the tool receptacle to the rotary tool.

In a further preferred embodiment, the long sides of each slaving rib extend essentially radially on a circumferential jacket face of the insert shaft. This embodiment represents a variant of the trapezoidal embodiment of the rib cross section in which the long sides are embodied as sides of a trapezoid that is disposed with its shorter side in the cross section of the insert shaft or on that, and the trapezoid is embodied minor-symmetrically such that its trapezoidal sides extend parallel or essentially parallel to the radius or are located on a radius that extends through the respective corners of the trapezoid that are associated with the cross section of the insert shaft. In this way, torque transmission of the rotary motion to the rotary tool can be achieved in which no substantial breakdown of force occurs, but instead the torque engages a radially located plane directly.

In a further preferred embodiment, the insert shaft has a circular cross section, beyond which the slaving ribs protrude at least in some regions. By means of the circular cross section, the insert shaft can easily be clamped in three-jaw chucks; in known three-jaw chucks, the clamping jaws are spaced apart from one another by angles of 120°. This allows a defined positional fixation in the tool receptacle. The slaving ribs protrude past this circular cross section in some regions and serve to transmit torque in the first type of tool receptacle, namely the form-locking receptacle. This protrusion is effected at least in some regions, or in other words not necessarily over the entire axial length of the insert shaft. As a result, on the one hand, further free spaces are created in the design and in the interoperability, but at the same time the widest possible range for clamping in the three jaw chuck is furnished.

In a further preferred embodiment, at least one of the slaving ribs has at least one axial interruption for axial locking. In a manner similar to known SDS-Plus tool receptacles, axial locking is effected by means of radially acting engagement of an axial locking element. In order not to have to provide the circular cross section of the insert shaft with recesses suitable for such engagement, which makes the clamping in three jaw chucks more difficult or, depending on the arrangement, impossible, the axial interruption of at least one of the slaving ribs is provided. This axial interruption is engaged by the axial locking element in the form-locking receptacle, and as a result, sliding of the rotary tool out of the tool receptacle in the axial direction is prevented. In principle, this kind of axial interruption is sufficient, but it is advantageous to provide an axial interruption in both of the slaving ribs, since the user of the handheld electric power tool in such a case need not take care to insert the rotary tool into the tool receptacle positionally correctly but instead can insert it arbitrarily into the corresponding form-locking receptacle, as long as the slaving ribs are capable of engaging grooves provided for the purpose.

In a further preferred embodiment, the diameter of the insert shaft in the region of the axial interruption is equal to the diameter in its slaving rib-free portion. The insert shaft is consequently continuously of circular cross section, and only at the places provided for the purpose do the slaving ribs protrude past this circular cross section. In the region of the axial interruption, however, the diameter of the insert shaft is an unchanged circular cross section with the same diameter as in the slaving rib-free portion.

In a further preferred embodiment, it is provided that the circumferential jacket face of the insert shaft, in the region of the slaving ribs, has jacket portions which, in a deviation from the circular cross section of the insert shaft, are embodied as essentially two-dimensional and essentially transversely to the slaving ribs. The insert shaft accordingly does not have a circular cross section in the region of the slaving ribs. The cross section here proves to be at least in some portions, for instance along the axial length of the slaving ribs, to be two-dimensional in some regions, and these jacket faces extend essentially transversely to the slaving ribs. Thus below the slaving ribs, the circular cross section has secants, on which the jacket faces are embodied and on each of which the cross section of the slaving ribs is disposed. This embodiment on the one hand allows even more effective form-locking without only slightly reduced interoperability with three jaw chucks and on the other it offers simplified, very economical manufacture, for instance by compressing the slaving ribs from the solid circular cross section.

In a further embodiment, in the region of the axial interruption and/or axially upstream and/or axially downstream of the slaving ribs, essentially flat faces are embodied in the circumferential jacket face and/or the diameter of the insert shaft is less than in its slaving rib-free region. Accordingly, the diameter of the insert shaft here is not continuously the same; instead, it is reduced in the region of the axial interruption and/or axially upstream and/or axially downstream of the slaving ribs. This diameter reduction can be effected by embodying essentially flat faces that are disposed in the region of the axial interruption and/or are located upstream and/or downstream of the slaving ribs, or by means of a circular embodiment as before of the insert shaft including in this region, but with a reduced diameter. In this embodiment, locking elements of the form-locking receptacle can engage better, because relative to the outer diameter of the insert shaft an indentation is created, which assures an improved hold of the rotary tool against axially sliding out of the form-locking receptacle. Preferably, a flat face is embodied of such a kind that, viewed in cross section of the rotary tool, it is located on a secant of the circular cross section of the insert shaft and extends essentially parallel to the axis of rotation of the rotary tool as well as essentially transversely, in particular at a right angle, to the axis of symmetry of the rib cross section of the slaving rib.

In a further preferred embodiment, the axial interruption divides the slaving rib into a first and a second axial rib portion, and the axial rib portions are not the same length. By means of the embodiment of the axial rib portions with different lengths, the axial interruption can be disposed at the place that is optimal for the best possible interoperability, in particular between the form-locking receptacle and the three jaw chuck, and at the same time simple, economical and effective disposition of the locking elements of the form-locking receptacle that engage the axial interruption is assured.

In a further preferred embodiment, it is provided that, viewed from a machining region of the rotary tool adjoining the insert shaft, the first axial rib portion is disposed upstream of the axial interruption and the second axial rib portion is disposed downstream of the axial interruption, and the first axial rib portion is longer than the second axial rib portion. Accordingly, on the circumference of the rotary tool, the slaving rib has two axial rib portions, namely one located closed to the machining region of the rotary tool and one located farther from the machining region and downstream of the axial interruption. The first axial rib portion, namely the one located closer to the machining region of the rotary tool, is embodied as longer than the second axial rib portion. By means of such an arrangement of axial rib portions, on the one hand very good torque transmission from the tool receptacle as a form-locking receptacle to the rotary tool can be accomplished; on the other, this offers great freedom in the disposition of the axial securing means for the rotary tool that engages the axial interruption. In the embodiment preferred here, with a shorter second axial rib portion, the securing means can be operative with even only brief engagement with the form-locking receptacle, and the tool receptacle as such can be embodied as relatively narrow, in particular toward its end oriented toward the rotary tool and the machining region thereof, because the disposition of the axial securing means in the tool receptacle can be located closer to the motor part.

In a further embodiment, it is provided that the diameter of the insert shaft is between 4 mm and 8 mm, preferably between 6.5 mm and 7 mm. The most common sizes of drills and dowels can be found in these ranges. The tool system is optimized with respect to these most-common sizes of drills and dowels.

In an especially preferred embodiment, the freedom from collision of the slaving ribs with clamping jaws of the three jaw chuck is assured in that the rotary tool has a rib radius A, which extends from an axis of rotation of the rotary tool as far as the top of the slaving rib, and a radius R, which refers to the circular cross-section of the insert shaft in the region of the slaving rib, and a slaving rib width M, which extends between the diametrically opposed slaving flanks of the slaving rib, and half thereof is the slaving rib half-width B, the geometrical relationship being

B<R−tan 30°×A.

The slaving rib width M thus, as a function of the maximum elevation of the slaving rib above the circular diameter of the insert shaft (referred to the axis of rotation as the rib radius A) results by providing that half of it, namely the slaving rib half-width B, is less than the radius R, minus the rib radius A, times the tangent of 30°. In converting this geometrical relationship, it is also true that the rib radius A must be less than the radius R minus the slaving rib half-width B, divided by the tangent of 30°. Or, using rounded numerical examples, the slaving rib half-width B can be calculated as the radius R minus the rib radius A times 0.577. Based on these geometrical relationships, the slaving ribs do not collide with the clamping jaws of three jaw chucks. As a result, it can specifically be assured that the outer edges of the slaving ribs are always located in a region of the three-jaw chuck that is not occupied by the clamping jaws of the three-jaw chuck, and if at all possible indeed rest on side flanks of the clamping jaw but not in such a way that the central clamping of the insert shaft between the three clamping jaws of the three jaw chuck is made more difficult or impossible. This geometrical relationship furthermore has the advantage that even when clamped in the three-jaw chuck, the slaving ribs prevent an unwanted slip of the rotary tool inside the three-jaw chuck under load, since the slaving ribs rest on side flanks of the clamping jaws. This prevents the tool from slipping through the chuck.

Further details are shown by the exemplary embodiments, in which in particular these geometrical relationships are further explained. Further advantageous embodiments will become apparent from the dependent claims and from combinations thereof.

The invention is explained in further detail below in terms of exemplary embodiments, without the invention being limited to them.

### BRIEF DESCRIPTION OF THE DRAWINGS

Shown are

FIG. 1, a rotary tool with an insert shaft;

FIG. 2, a schematically shown first tool receptacle, which is embodied as a form-locking receptacle for the insert shaft;

FIG. 3, a geometrical illustration of the insert shaft in a further tool receptacle, embodied as a three jaw chuck; and

FIG. 4, a further embodiment of the insert shaft with two-dimensional jacket portions.

### EMBODIMENT(S) OF THE INVENTION

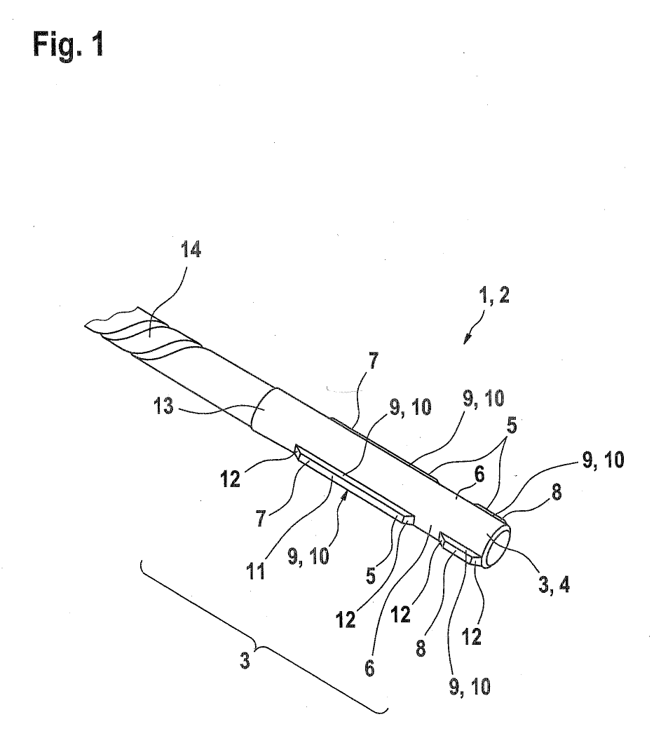

FIG. 1 shows a rotary tool 1, namely a drill 2, for use in a handheld electric power tool, not shown here, for which purpose the rotary tool 1 has an insert shaft 3 that serves to receive the rotary tool 1 in a tool receptacle, not shown. The insert shaft 3 is embodied as an SDS-Mini insert shaft 4. Over its circular cross section, this shaft has diametrically opposed, axially extending slaving ribs 5, which each have one axial interruption 6, which divides each slaving rib into a longer, first axial rib portion 7 and a shorter, second axial rib portion 8 downstream of the axial interruption, aligned toward the end of the rotary tool. The slaving ribs 5 have diametrically opposed long sides 9 on each slaving rib 5, which form slaving flanks 10. Between the long sides 9, closing off the slaving ribs 5 toward the outside and at the top, there are top sides 11. The slaving flanks 10 with the top sides 11 form essentially a right angle, and as a result the slaving flanks 10 extend essentially parallel to one another. The slaving flanks 10 have face ends 12, on the front end and the other end and adjoining the axial interruption 6, which with the top side 11 form an acute angle, such that they form an approach and exit of the top side 11 to the circumferential jacket face 13 of the insert shaft 3. This reduces the risk of injury to a user from sharp edges upon insertion and removal into and from the corresponding tool receptacle, not shown here, and while the user is manipulating the power tool. The insert shaft 3 is adjoined in the axial length of the rotary tool 1 by a machining region 14, which serves the purpose of machining a workpiece, not shown.

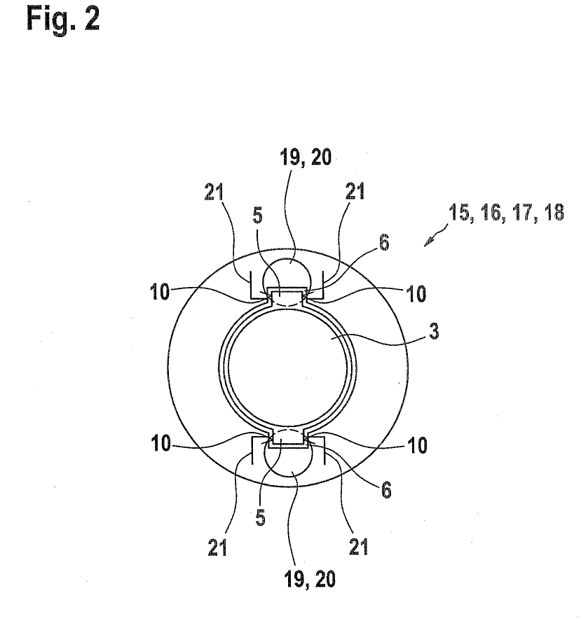

FIG. 2 shows a tool holder 15, namely a first type 16 of a tool receptacle 17, which is embodied as a form-locking receptacle 18. It is intended to receive the SDS-Mini insert shaft 4 described in FIG. 1. It has an axial securing means 20, constructed for instance of two blocking ball devices 19, which engages the axial interruption 6, shown in FIG. 1, of each slaving rib 5 of the insert shaft 3 and prevents it from sliding axially out of the tool holder 15. At the same time, the tool holder 15 has torque transmitters 21, which engage the slaving ribs 5 laterally, namely on their slaving flanks 10. As a result, torque transmission is accomplished between the tool receptacle 17 and the insert shaft 3.

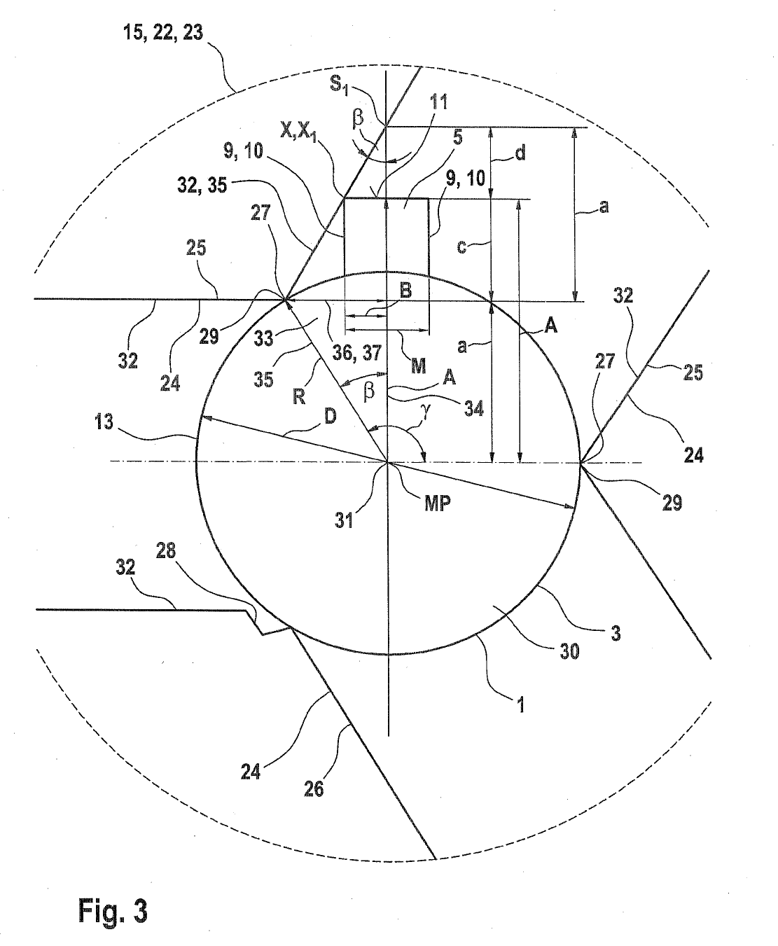

FIG. 3 shows the rotary tool 1, whose insert shaft 3 is clamped in a tool holder 15 of a second type 22, namely a three jaw chuck 23. This chuck has three clamping jaws 24, which may be embodied as full-closure clamping jaws 25 that close down to zero or as spacing clamping jaws 26 that do not close down to zero. For the sake of simplicity, in the present illustration, two full-closure clamping jaws 25 and one spacing clamping jaw 26 are shown; it is understood that in one three jaw chuck 23, only three clamping jaws each of the same type occur, namely either full-closure clamping jaws 25 that clamp down to 0 mm, or in a certain sense arbitrarily small diameters, or as spacing clamping jaws 26 that clamp only beyond a certain minimum diameter. For clamping purposes, full-closure clamping jaws 25 have an essentially linear axial clamping edge 27, while spacing clamping jaws 26 have a longitudinally extended clamping groove 28. When a clamping groove 28 is embodied on spacing clamping jaws 26, there are two lines of contact 29 on the circumferential jacket face 13 of the insert shaft 3 for each clamping jaw 24, while with full-closure clamping jaws 25, there is only one clamping edge 26 as a line of contact 29 on the circumferential jacket face 13 of the insert shaft 3. Still other embodiments of spacing clamping jaws 26 are known, which, although they do have a clamping groove 28, nevertheless because of their position and manner of clamping touch the insert shaft 3 with only one edge of the clamping groove 28 each, so that effectively, there is once again only a single clamping edge 27 per clamping jaw 24, and accordingly also only one line of contact 29. In particular, spacing clamping jaws 26 (not shown here) are also known that have a clamping face rather than a clamping groove 28.

For the sake of simplicity and greater clarity, only one slaving rib 5 is shown on the present insert shaft 3.

Between the clamping jaws 24, or the lines of contact 29 of the full-closure clamping jaws 25 (which will be the only kind considered for the sake of this discussion), an angle γ of 120° is enclosed, since the clamping jaws 24, or their line of contact 29 on the circumferential jacket face 13, are disposed in a circle, spaced apart by equal angles, in order to embody a defined fixation of the insert shaft 3. The insert shaft 3 has a radius R, which extends on its circular cross section 30 between its center point MP or on an axis of rotation 31 and the circumferential jacket face 13 of the insert shaft 3. At the same time, the diameter D of the insert shaft 3, which is twice the radius R, extends through the center point MP. Between the axis of rotation 31 or the center point MP and the top side 11 of the slaving rib 5, there is a resultant rib radius A. There is also a slaving rib width M as the spacing between the long sides 9 or slaving flanks 10 of the slaving rib 5. Half the slaving rib width M is the slaving rib half-width B, which results such that the slaving rib width M is divided centrally by the rib radius A. So that the clamping jaws 24, with their side flanks 32, will not collide with the edges X located between the top side 11 and the long sides 9 of the slaving ribs 5, illustrated here in terms of the edge X₁ of the slaving rib 5, the following geometrical relationship applies:

slaving rib half-width B<radius R−tangent 30°×rib radius A.

The angle β of 30° results as between the side flank 32 of the clamping jaw 24 and the extension of the rib radius A past the top side 11 of the slaving rib 5. Conventional three jaw chucks 23 have this kind of flank geometry. The angle is repeated between the rib radius A and the radius R, and the radius R is referred to the clamping edge 27 of the clamping jaw 24. The result is an isosceles triangle 33, above whose base 34 and between whose legs 35 as a secant 36 beyond the clamping edge 27, a height 37 of the isosceles triangle 33 is located. Up to the point of intersection S₁ of the extension of the rib radius A into the flank 32 of the clamping jaw 24, the secant 36 results in the distance a, which is divided into the secant height c, resulting from the spacing between the top side 11 and the secant 36, and the free space d between the top side 11 and the point of intersection S₁. The distance a is equal to the sum of the secant height c and the free space d. The spacing between the center point MP and the secant 36 is also equal to the distance a. The resultant limit conditions to assure that the slaving ribs 5 will not collide with clamping jaws 24 of the three jaw chuck 23 are the following:

tan 30°=B/d,

from which it follows that

B=tan 30°×d,

from which it follows that

d=a−c

and

A=a+c

and

c=A−a.

The cosine of 30° is a/R. In a computational application, the slaving rib half-width B can thus be obtained as the radius R−rib radius A×tangent 30°, or rounded values, as the radius R−0.577×rib radius A.

When spacing jaws 26 are used, the rib cross section of the slaving ribs 5 should be embodied somewhat smaller than shown, to take into account the manifold forms of spacing jaws 26 that exist. Particularly in unfavorable cases it is conceivable that the slaving rib 5 will collide at its edge X₁ with the flank 32 of a spacing clamping jaw 26, if the above limit conditions are fully exploited, depending on the actual design of the spacing clamping jaw 26. For that reason, for reliably collision-free use, the slaving rib width M and/or the secant height c should be reduced yet again (slightly), compared to the limit conditions described above for full-closure clamping jaws 25.

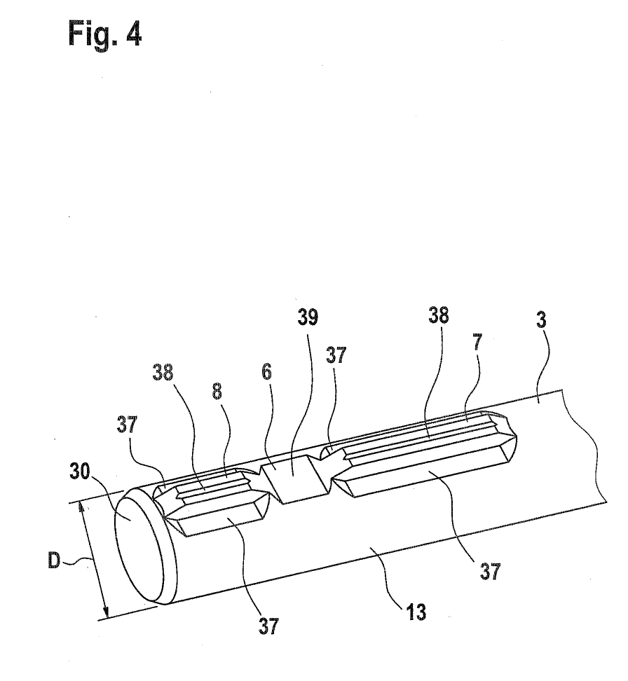

FIG. 4 shows a further embodiment of the insert shaft 3 with the first axial rib portion 7 and the second axial rib portion 8. To the left and right—viewed in the axial direction—of the axial rib portions 7, 8, flat jacket portions 37 are embodied in the circumferential jacket face 13, which extend essentially transversely to the axial rib portions 7, 8. In this region, the insert shaft 3 does not have a circular cross section 30 with the diameter D; instead, the circumferential jacket face 13 is indented to embody the jacket portions 37. The jacket portions 37 can be obtained in the course of the manufacture of the axial rib portions 7, 8 from the round solid material of the insert shaft 3, in that the axial rib portions are compressed out of the round solid material. This causes a shifting of material that creates the indentations in the jacket portions 37 by shifting solid material originally located there into the region of the resultantly embodied axial rib portions 7, 8. Accordingly, the entire contour of the insert shaft 3 can be produced in a simple pressing or compression operation. By compression done from both sides and the resultant material shifting, flow lines 38 result on the top sides of the axial rib portions 7, 8 and can be used for instance as further guide grooves. The axial interruption 6 is disposed between the axial rib portions 7, 8 and is embodied as a flat face 39, such that it is lowered relative to the circumferential jacket face 13 and in its course is transverse to the axial rib portions 7, 8. By the embodiment of the flat face 39, the axial securing means 20, not shown here, can engage better; accordingly, the coverage between the insert shaft 3 and the axial securing means 20 becomes greater and the effectiveness of the axial securing means 20 is accordingly increased.

1-19. (canceled)

20. A tool system comprising:
an interchangeable rotary tool for handheld electric power tools, preferably with a drilling and/or hammering function, in particular for an electric rotary hammer, and an electric power drill, in particular a percussion power drill;
at least two tool holders as a tool receptacle, which are associated with the handheld power tools and are of different types, wherein the rotary tool has an insert shaft for reception in a respective tool holder of the handheld power tools, which insert shaft has two slaving ribs for rotary slaving, extending along a length of the insert shaft and diametrically opposite one another,
the tool receptacle being embodied as a form-locking receptacle as a first type and a further tool receptacle is embodied as a multi jaw chuck as a second type, wherein the slaving ribs are embodied with a width and height such that—in a clamped state—the slaving ribs have a lateral spacing from the clamping jaws of the multi jaw chuck.

21. The tool system as defined by claim 20, wherein the insert shaft has precisely two slaving ribs.

22. The tool system as defined by claim 20, wherein the slaving rib has an essentially square or rectangular rib cross section.

23. The tool system as defined by claim 20, wherein the slaving rib has an essentially trapezoidal rib cross section.

24. The tool system as defined by claim 20, wherein the slaving rib has a rib cross section embodied as essentially mirror-symmetrical to an axis of symmetry, extending through the rib cross section, that is formed as an extension of a radius R of the insert shaft.

25. The tool system as defined by claim 20, wherein the slaving ribs have long sides, which form flat slaving flanks.

26. The tool system as defined by claim 25, wherein the long sides of each slaving rib extend parallel to one another.

27. The tool system as defined by claim 25, wherein the long sides of each slaving rib extend essentially radially on a circumferential jacket face of the insert shaft.

28. The tool system as defined by claim 20, wherein the insert shaft has a circular cross section, beyond which the slaving ribs protrude radially in at least in some regions.

29. The tool system as defined by claim 28, wherein the circumferential jacket face of the insert shaft, in a region of the slaving ribs, has jacket portions which, in a deviation from the circular cross section of the insert shaft, are embodied as essentially two-dimensional and essentially transversely to the slaving ribs.

30. The tool system as defined by claim 29, wherein at least one of the slaving ribs has at least one axial interruption for axial locking.

31. The tool system as defined by claim 30, wherein the diameter of the insert shaft in a region of the axial interruption is equal to the diameter in its slaving rib-free portion.

32. The tool system as defined by claim 31, wherein in the region of the axial interruption and/or axially upstream and/or axially downstream of the slaving ribs, essentially flat faces are embodied in the circumferential jacket face and/or the diameter of the insert shaft is less than in a region free of slaving ribs.

33. The tool system as defined by claim 30, wherein the axial interruption divides the slaving rib into a first and a second axial rib portion, and the axial rib portions have a different length.

34. The tool system as defined by claim 33, wherein, viewed from a machining region of the rotary tool adjoining the insert shaft, the first axial rib portion is disposed upstream of the axial interruption and the second axial rib portion is disposed downstream of the axial interruption, and the first axial rib portion is longer than the second axial rib portion.

35. The tool system as defined by claim 20, wherein the diameter of the insert shaft is between 4 mm and 8 mm, preferably between 6.5 mm and 7 mm.

36. The tool system as defined by claim 20, wherein the rotary tool has a rib radius A, which extends from an axis of rotation of the rotary tool as far as a top of the slaving rib, and a radius R, which refers to a circular cross section of the insert shaft in a region of the slaving rib, and a slaving rib width M, which extends between diametrically opposed slaving flanks of the slaving rib, and half thereof is a slaving rib half-width B, a geometrical relationship thereof being defined by
B<R−tan 30°×A.

37. The tool system as defined by claim 20, wherein the rotary tool is produced by means of a chipless pressing operation.

38. The tool system as defined by claim 20, wherein the multi-jaw chuck is embodied as a three jaw chuck.

39. The tool system as defined by claim 20, wherein at least one of the slaving ribs has at least one axial interruption for axial locking.
